(19) United States
(12) Patent Application Publication
(10) Pub. No.: US 2023/0333215 A1
(43) Pub. Date: Oct. 19, 2023

(54) DEVICE AND METHOD FOR GENERATING IMAGE AND DISTANCE INFORMATION

(71) Applicant: Technion Research & Development Foundation Ltd., Haifa (IL)

(72) Inventors: Ayal Eshkoli, Kiryat Tivon (IL); Yael Nemirovsky, Haifa (IL)

(73) Assignee: Technion Research & Development Foundation Ltd., Haifa (IL)

(21) Appl. No.: 17/918,893

(22) PCT Filed: Apr. 12, 2021
(86) PCT No.: PCT/IB2021/053003

§ 371 Date: Oct. 13, 2022

Related U.S. Application Data
(60) Provisional application No. 63/009,593, filed on Apr. 14, 2020.
(60) Provisional application No. 63/009,602, filed on Apr. 14, 2020.

(51) Int. Cl. G01S 7/4861; H04N 25/77; G01S 7/481; G01S 17/89; G01S 7/4865

(52) U.S. Cl. CPC G01S 7/4861; H04N 25/77; G01S 7/4816; G01S 17/89; G01S 7/4865

(57) ABSTRACT

A device that may include a transmitter that is configured to transmit, per each sensing iteration, a radiation pulse; an array of pixels, each pixel comprises multiple subpixels, each subpixel comprises single photon avalanche diodes (SPADs) that are coupled to each other in parallel, and one or more quenching circuits, wherein each subpixel is configured to output a subpixel output signal indicative of a reflected radiation pulse sensed by one or more SPADs of the subpixel; wherein the reflected radiation pulse is reflected from an area of an object that was illuminated by the radiation pulse; and a processing circuit that is configured to: read, for each pixel, multiple subpixel output signals from the multiple subpixels of the pixel; receive, per each sensing iteration, transmission timing information indicative of a timing of transmission of the radiation pulse; and determine, per each sensing iteration and per each subpixel, a timing of a first detection of the reflected pulse detected by any of the SPADs of the subpixel.

### CROSS REFERENCE

This application claims priority from U.S. provisional patent application No. 63/009,602 filing date Apr. 14, 2020 and U.S. provisional patent application No. 63/009,593 filing date Apr. 14, 2021—both being incorporated herein by reference.

### BACKGROUND OF THE INVENTION

Ultra-sensitive light detection systems are increasingly being employed in applications such as mobile range finding, automotive ADAS (Advanced Driver Assistance Systems), gesture recognition, 3D mapping, security, etc.

Therefore, there is an increasing need for a device that is reliable, fast, cheap and can provide distance information.

Therefore there is a growing need to provide a device that can provide image information in an efficient manner.

### SUMMARY

There may be provided a device that may include a transmitter that may be configured to transmit, per each sensing iteration, a radiation pulse; an array of pixels, each pixel may include multiple subpixels, each subpixel may include single photon avalanche diodes (SPADs) that may be coupled to each other in parallel, and one or more quenching circuits, each subpixel may be configured to output a subpixel output signal indicative of a reflected radiation pulse sensed by one or more SPADs of the subpixel; the reflected radiation pulse may be reflected from an area of an object that was illuminated by the radiation pulse; a processing circuit that may be configured to (a) read, for each pixel, multiple subpixel output signals from the multiple subpixels of the pixel; (b) receive, per each sensing iteration, transmission timing information indicative of a timing of transmission of the radiation pulse; and (c) determine, per each sensing iteration and per each subpixel, a timing of a first detection of the reflected pulse detected by any of the SPADs of the subpixel.

The processing circuit may include time window circuits for ignoring pixel output signals generated outside programmable time windows.

The time window circuits may be configured to control latches that selectively output pixel output signals.

The processing circuit may include a code generator that may be configured to output a sequence of codes, starting from an initial code per each sensing iteration.

The code generator may be a pseudo random code generator.

The processing circuit may include code samplers; each code sampler may be associated with a pixel and may be configured to sample, at each sensing iteration, the code generator at a timing that correspond to the timing of a first detection of radiation by the pixel.

The processing circuit may include a decision circuit for each pixel; the decision circuit may be configured to determine whether the pixel sensed a reflected radiation pulse per each sensing iteration; and to generate a pixel output signal according to the determination.

The device may include a bias circuit for biasing each decision circuit with one or more bias signals, the decision circuit may be configured to make the determination whether the pixel sensed the radiation pulse based on the one or more bias signal.

The device may include a controller for determining the one or more bias signals.

The controller may be configured to determine the one or more bias signals based on outcomes of previous sensing iterations.

The controller may be configured to determine the one or more bias signals based on signal to noise ratio.

The device each SPAD may be coupled to a single quenching circuit that consists essentially of a resistor.

The processing circuit may be configured to determine, per each sensing iteration and per each pixel, an intensity parameter related to one or more reflected radiation pulses detected by the pixel.

There may be provided a method that may include transmitting, by a transmitter, per each sensing iteration, a radiation pulse; outputting, by each subpixel of an array of pixels, a subpixel output signal indicative of a reflected radiation pulse sensed by one or more single photon avalanche diodes (SPADs) of the subpixel; each pixel of the array may include multiple subpixels; the SPADs of each subpixel may be coupled to each other in parallel; each subpixel may include one or more quenching circuits, the reflected radiation pulse may be reflected from an area of an object that was illuminated by the radiation pulse; reading, by a processing circuit for each pixel, multiple subpixel output signals from the multiple subpixels of the pixel; receiving, per each sensing iteration, transmission timing information indicative of a timing of transmission of the radiation pulse; and determining, by the processing circuit and per each sensing iteration and per each subpixel, a timing of a first detection of the reflected pulse detected by any of the SPADs of the subpixel.

The method may include determining, by the processing circuit and per each sensing iteration and per each pixel, an intensity parameter related to one or more reflected radiation pulses detected by the pixel.

The method may include controlling by the time window circuits latches that selectively output pixel output signals.

The method may include outputting, by a code generator of the processing circuit, a sequence of codes, starting from an initial code per each sensing iteration.

The code generator may be a pseudo random code generator.

The method may include sampling, by each code sampler of the processing circuit, at each sensing iteration, the code generator at a timing that correspond to the timing of a first detection of radiation by a pixel associated with the code sampler.

The method may include determining, by each decision circuit of the processing circuit, whether a pixel associated with the decision circuit sensed a reflected radiation pulse per each sensing iteration; and generating, by the decision circuit, a pixel output signal according to the determination.

The method may include biasing each decision circuit by a bias circuit associated with the decision circuit and the determining may be based on the one or more bias signal.

The method may include determining, by a controller, the one or more bias signals.

The method may include determining by the controller the one or more bias signals based on outcomes of previous sensing iterations.

The method may include determining by the controller the one or more bias signals based on signal to noise ratio.

The method each SPAD may be coupled to a single quenching circuit that consists essentially of a resistor.

The method may include determining, by the processing circuit, per each sensing iteration and per each pixel, an intensity parameter related to one or more reflected radiation pulses detected by the pixel.

There may be provided a device that may include an array of pixels, each pixel may include multiple subpixels, each subpixel may include single photon avalanche diodes (SPADs) that may be coupled to each other in parallel, and one or more quenching circuits, each subpixel may be configured to output a subpixel output signal indicative of a radiation sensed by one or more SPADs of the subpixel; and a processing circuit that may be configured to: (a) read, for each pixel, multiple subpixel output signals from the multiple subpixels of the pixel; and (b) generate, based on the multiple subpixel output signals, at least one pixel output signal indicative of radiation sensed by at least one of the SPADs of the array.

Each SPADs may be coupled to a single quenching circuit that consists essentially of a resistor.

The processing circuit may be configured to determine, per each sensing iteration and per each subpixel, a timing of a first detection of radiation by any SPAD of the subpixel.

The processing circuit may be configured to determine, per each sensing iteration and per each pixel, an intensity parameter related to radiation detected by the pixel.

The processing circuit may be configured to determine, per each sensing iteration and per each subpixel, a timing of a first detection of radiation by any SPAD of the subpixel.

The processing circuit may be configured to determine, per each sensing iteration and per each subpixel, timings of detection of radiation by different SPAD of the subpixel.

Each subpixel output signal may be a superposition of SPAD detection signals of SPADs that belong to the subpixel.

The processing circuit may be configured to determine a validity of one or more SPAD detection signals of the subpixel output pixel.

The processing circuit may be configured to ignore a SPAD detection signal that may be invalid.

The SPADs may be backside illumination SPADs.

The array of pixels may be located in a first integrated circuit, the processing circuit may be located at a second integrated circuits; and the device may include inter-chip conductors for electrically coupling the array of pixels to the processing circuit.

The device may include lenses that precede the array of pixels.

There may be provided a method that may include sensing, during a sensing iteration, at least one radiation pulse by at least one photon avalanche diode (SPADs) of an array of pixels, each pixel of the array may include multiple subpixels, and each subpixel may include a group of SPADs, SPADs of a subpixel may be coupled to each other in parallel; outputting, by each subpixel, a subpixel output signal that may be indicative any radiation pulse that impinged on any of the SPADs of the group; reading by a processing circuit, for each pixel, multiple subpixel output signals from the multiple subpixels of the pixel; and generating by the processing circuit, based on the multiple subpixel output signals, at least one pixel output signal indicative of the radiation sensed by the at least one SPAD of the array.

Each SPAD may be coupled to a single quenching circuit that consists essentially of a resistor.

The method may include determining, by the processing circuit, per each sensing iteration and per each subpixel, a timing of a first detection of radiation by any SPAD of the subpixel.

The method may include determining, by the processing circuit, per each sensing iteration and per each pixel, an intensity parameter related to radiation detected by the pixel.

The method may include determining, by the processing circuit, per each sensing iteration and per each subpixel, a timing of a first detection of radiation by any SPAD of the subpixel.

The method may include determining, by the processing circuit, per each sensing iteration and per each subpixel, timings of detection of radiation by different SPAD of the subpixel.

Each subpixel output signal may be a superposition of SPAD detection signals of SPADs that belong to the subpixel.

The method may include determining, by the processing circuit, a validity of one or more SPAD detection signals of the subpixel output pixel.

The method may include ignoring, by the processing circuit, a SPAD detection signal that may be invalid.

The SPADs may be backside illumination SPADs.

The array of pixels may be located in a first integrated circuit, the processing circuit may be located at a second integrated circuits; and the device may include inter-chip conductors for electrically coupling the array of pixels to the processing circuit.

The method may include lenses that precede the array of pixels.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an example of a device;

FIG. 2 is an example of a device and of an illuminated object;

FIG. 3 is an example of a part of a processing circuit;

FIG. 4 is an example of a part of a processing circuit;

FIG. 5 is an example of a subpixel output signal;

FIG. 6 is an example of a part of a processing circuit;

FIG. 7 is an example of a part of a processing circuit;

FIG. 8 illustrates examples of a pixel and optics of the device;

FIG. 9 illustrates examples of pixels and optics of the device;

FIG. 10 is an example of an array of pixels of the device;

FIG. 11 is an example of a part of the device;

FIG. 12 is an example of a part of the device;

FIG. 13 is an example of a method; and

FIG. 14 is an example of a method.

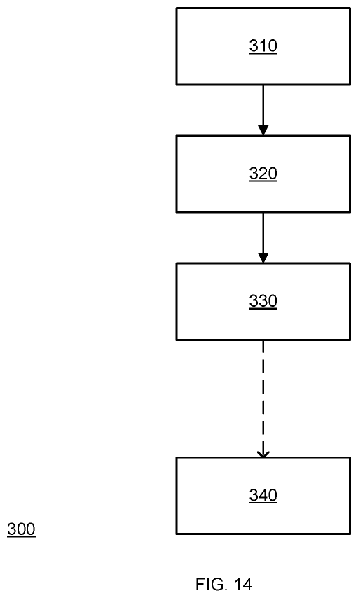

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device capable of executing the method.

Any reference in the specification to a device should be applied mutatis mutandis to a method that may be executed by the device.

The term “comprising” is synonymous with (means the same thing as) “including,” “containing” or “having” and is inclusive or open-ended and does not exclude additional, unrecited elements or method steps.

The term “consisting” is a closed (only includes exactly what is stated) and excludes any additional, unrecited elements or method steps.

The term “consisting essentially of” limits the scope to specified materials or steps and those that do not materially affect the basic and novel characteristics.

In the claims and specification any reference to the term “comprising” (or “including” or “containing”) should be applied mutatis mutandis to the term “consisting” and should be applied mutatis mutandis to the phrase “consisting essentially of”.

In the claims and specification any reference to the term “consisting” should be applied mutatis mutandis to the term “comprising” and should be applied mutatis mutandis to the phrase “consisting essentially of”.

In the claims and specification any reference to the phrase “consisting essentially of” should be applied mutatis mutandis to the term “comprising” and should be applied mutatis mutandis to the term “consisting”.

For simplicity of explanation the following text will refer to Silicon LEDS and Silicon multipliers although it is applicable mutatis mutandis to other types of LEDs and other types of multipliers.

There may be provided a device that may include an array of pixels.

The device may be a sensor, may be a mobile communication device, may include one or more integrated circuits, may be a camera, may be an image sensor, and/or may be any device that acquired images.

Referring to the array of pixels—each pixel may include multiple subpixels.

Each subpixel may include single photon avalanche diodes (SPADs) that are coupled to each other in parallel, and one or more quenching circuits.

The SPADs may be coupled in parallel via alternating current (AC) coupling capacitors.

The SPADs of each subpixel may form a photomultiplier—such as but not limited to a silicon multiplier (SM).

Each subpixel is configured to output a subpixel output signal indicative of a radiation sensed by one or more SPADs of the subpixel.

It is assumed that the radiation that is sensed is a radiation pulse—especially a reflected radiation pulse.

The device may also include a processing circuit that is configured to: (i) read, for each pixel, multiple subpixel output signals from the multiple subpixels of the pixel; and (ii) generate, based on the multiple subpixel output signals, at least one pixel output signal indicative of radiation sensed by at least one of the SPADs of the array.

Each SPAD may be coupled to a single quenching circuit that consists essentially of a resistor. Such a quenching circuit is compact.

The device is configured to operate in iterations that are referred to as sensing iteration.

During each sensing iteration the device may acquire one or more images. The acquisition of the one or more images may involve transmitting one or more radiation pulses.

For simplicity of explanation it is assumed that a single image is acquired by the device during a single sensing iteration.

The processing circuit may be configured to determine, per each sensing iteration and per each subpixel, reception timing information—such as a timing of a first detection (or of yet another detection) of radiation by any SPAD of the subpixel. Thus—the device exhibits a response time of a single SPAD—and is very fast.

The reflected radiation pulse that is detected by a subpixel may be a reflected by an area of an object that was illuminated by a radiation pulse that was transmitted from a transmitter. The transmitter may or may not belong to the device.

The reception timing information may be used (in conjunction with the transmission timing) to detect a distance between the device and the area of the object.

The processing circuit may be configured to determine, per each sensing iteration and per each pixel, intensity information related to radiation detected by the pixel.

The intensity information may represent radiation that was sensed by one, some or all SPADs of the subpixel. For example—the intensity information may reflect the number of SPADs that detected, during a single sensing iteration, radiation.

Accordingly—the device may provide at least one out of intensity information and distance information. Thus—the device may provide 2D information and/or distance information.

Because different SPADs may detect different photons of the same radiation pulse (during each sensing iteration)—they operate in a certain sense in parallel to each other—and each subpixel is capable of sensing multiple photons in parallel. There is no need to wait the entire dead time (time of recovery of a SPAD after the detection of a photon)—thus the suggested device is faster than a single-SPAD pixel.

Furthermore—having multiple SPADs per pixel allows to provide intensity information in a very fast manner.

Due to the parallel coupling between the SPADs of each subpixel—the subpixel output signal may include (for example—may be a superposition of) SPAD detection signals of SPADs that belong to the subpixel.

The subpixel output signal and/or the pixel output signal may be analyzed in order to detect whether SPAD detection signals are valid or not.

The analysis of a subpixel output signal may include comparing the subpixel output signal to a reference subpixel output signal, and/or checking whether the pattern formed by the SPAD detection signals is a valid pattern or not.

For example—a subpixel output signal that includes only a single SPAD detection signal can be deemed invalid—as resulting from a noise or another error.

The reference subpixel output signal signal and/or what can be regarded as a valid pattern may be fed to the device, learnt by the device, may dynamically change, may be fixed, and the like.

The validity of a subpixel output signal may be determined based on a number of peaks, intensity of the peaks, timing differences between the peaks, and the like.

The checking of the validity of the subpixel output signal may be performed in the digital domain and/or in the analog domain.

The processing circuit may validate the number of SPADs that detected radiation—and the pixel intensity information may reflect a validated number of SPADs of that pixel that detected radiation.

The processing circuit may be configured to process multiple subpixels and generate a pixel output signal. The processing may include checking whether enough subpixels detected radiation.

The pixel output signal may be, for example, a single bit output signal but this is not necessarily so. The single bit output signal may represent timing information.

Additionally or alternatively, the processing circuit may output pixel intensity information—which may include multiple bits.

The SPADs may be backside illumination SPADs or frontside illumination SPADs.

When using a backside illumination SPAD, the path that the radiation passes till reaching the anode of the SPAD is longer than the corresponding path in a frontside illumination SPAD—thus the backside illumination SPAD may detect radiation of longer wavelengths.

Using radiation of longer wavelength (>900 nm) can allow the device to detect radiation that does not damage a human eye—and enable a LIDAR system to transmit radiation at higher levels without damaging the eyes of the humans.

Any array of pixel illustrated in any of the drawings may be preceded by optics such as lenses, filters, polarizers and the like. For example—the different pixels may be preceded by color filters arranged in any manner—Bayer or non-Bayer arrays.

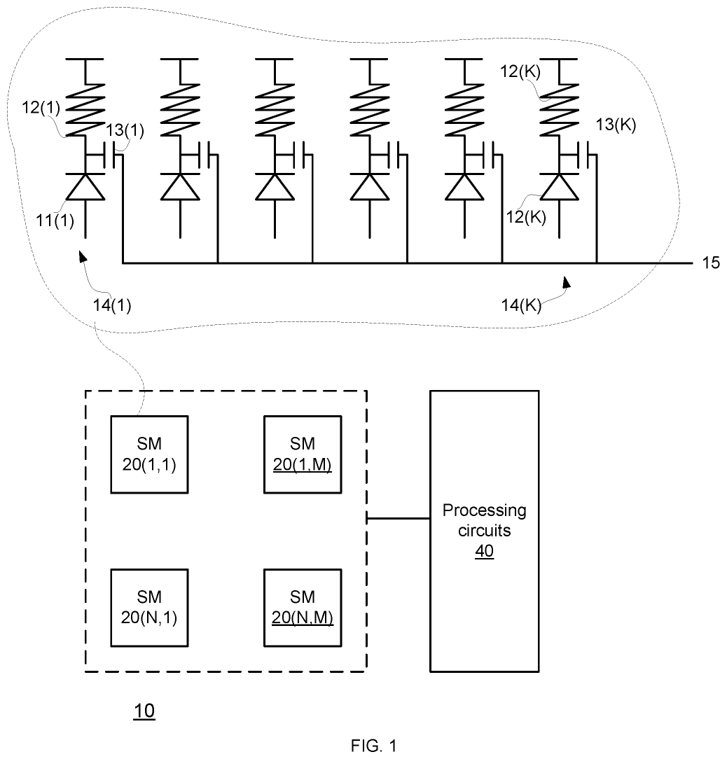

FIG. 1 illustrates a device 10 that includes an array of N×M pixels (each pixel is a silicon multipliers). The N×M pixels are arranged in N rows and M columns and are denoted SM 20(1,1)-20(N,M).

Each pixel may include multiple repetitions of sensing branches, each sensing branch includes (or consists essentially of) a SPAD and a quenching circuit (such as single resistor that is serially coupled to the SPAD).

The sensing branches (especially the junction between the resistor and the SPAD) of a pixel may be arranged in subpixels. The sensing branches of each subpixel are coupled in parallel to each other via AC capacitors.

FIG. 1 illustrates K sensing branches 14(1)-14(K) of a certain subpixel.

The K sensing branches include K SPADs 11(1)-11(K), and K resistors 12(1)-12(K). The sensing branches are coupled to K capacitors 13(1)-13(K).

The subpixel has a subpixel output port 15 for outputting a subpixel output signal that may include (or may otherwise reflect) SPAD detection signals from any of the K sensing branches.

K is an integer that exceeds 1. For example—a pixel that includes 1600 SPADs may include 16 subpixels of 100 SPADs each.

The number of subpixels per pixel and the number of SPADs per subpixel may differ from those illustrated above.

The device 10 also includes a processing circuit 40 that is coupled to the array of pixels. The processing circuit 40 may determine timing information and/or intensity information for each pixel of the array and may generate a 2D image and/or a 3D image per each sensing iteration.

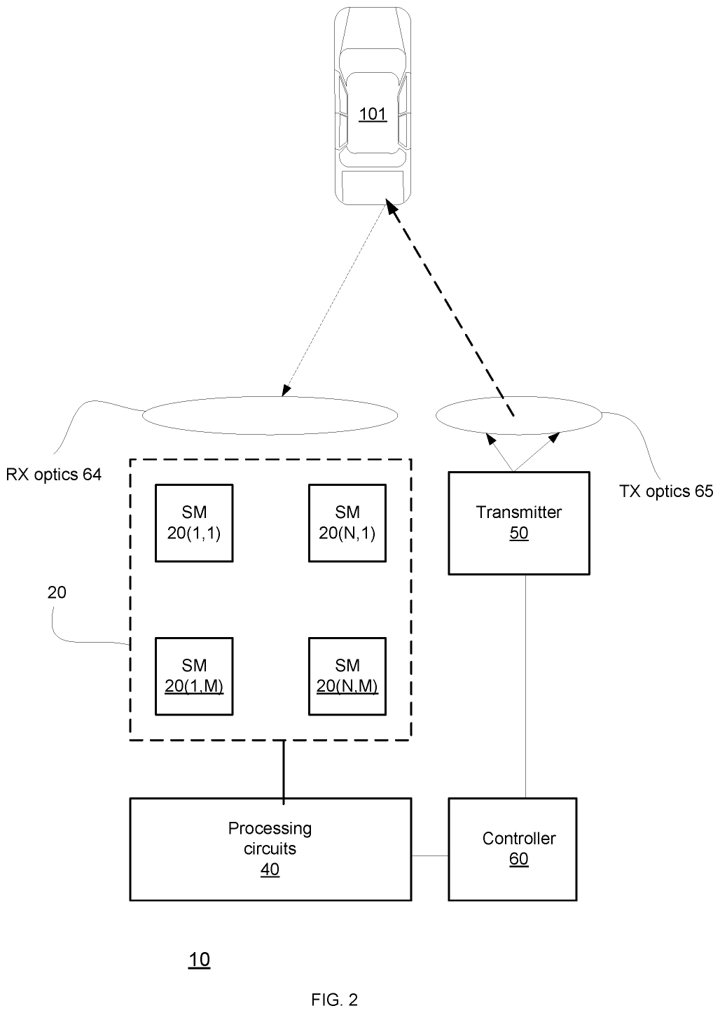

FIG. 2 illustrates a device 10 and an object 99.

The device includes an array of pixels 20, processing circuit 40, transmitter 50, controller 60, reception path optics (RX optics) 64 and transmission path optics (TX optics) 65.

Controller 60 controls the transmitter 50, the array of pixels 20 and the processing circuit.

Controller 60 may instruct the transmitter 50 to transmit radiation pulses, and may provide the processing circuit 40 with transmission timing information indicative of a timing of transmission of the radiation pulse.

Processing circuit 40 may determine time of flight and hence the distance (for each pixel that received reflected radiation) between the device and each area of each object that reflected radiation towards the pixel.

Device 10 may be a LIDAR or included in a LIDAR—and may use a static array of pixels 20—that increases the accuracy of the device and reduces the cost of the device.

Nevertheless—the device 10 may include mechanical elements for mechanically scanning the array of pixels 20—thereby covering larger fields of view with a smaller array of pixels.

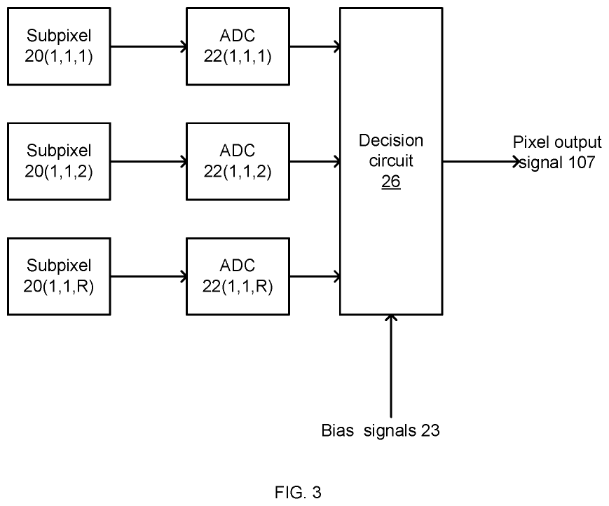

FIG. 3 illustrates a part of processing circuit 40.

It is assumed that pixel 20(1,1) includes R subpixels, R being a positive integer that exceeds two.

The R subpixels are denoted 20(1,1,1)-20(1,1,R).

The R subpixels output R analog subpixel output signals that are converted to R digital signals by R analog to digital converters ADCs 22(1,1,1)-22(1,1,R).

The R digital signals are fed to decision circuit 26.

Decision circuit 26 is also fed by bias signals 23 that may dynamically determine a minimal number of SPADs that should detect a radiation pulse (during a sensing iteration) in order to deem the detection as valid—and cause a one-bit pixel output signal to be set (or any value that is indicative of a detection of a radiation pulse) when the number of SPADs that detected a radiation pulse equals or exceeds the minimal number.

It should be noted that each ADC can be calibrated by a reference voltage provided to it, thus sampling the subpixel output signal to the desired level. This converter enables the determination of threshold voltage and thus effectively serves as a filter that allows determining the minimum amount of pixels that must be fired in order to detect a real event rather than false firing due to noise.

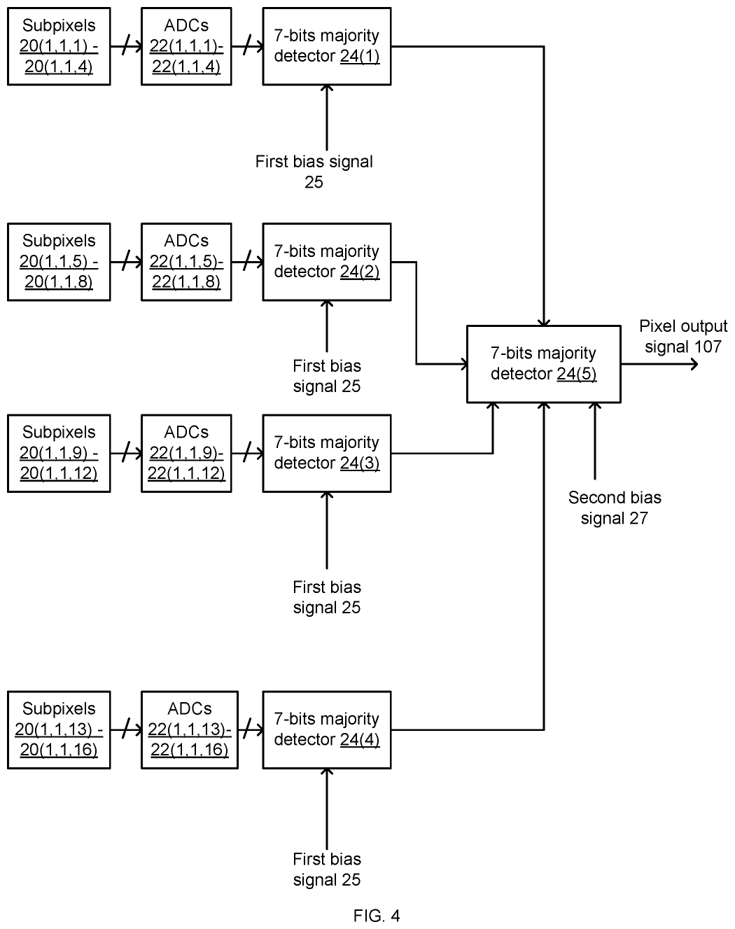

FIG. 4 illustrates a part of processing circuit 40.

It is assumed that pixel 20(1,1) includes sixteen subpixels that are denoted 20(1,1,1)-20(1,1,16). These subpixels are followed by sixteen ADCs 22(1,1,1)-22(1,1,16) that are followed by four 7-bits majority detectors 24(1)-24(4) that are followed by a fifth 7-bits majority detector 24(5).

Each ADCs may be a one-bit ADC that outputs digital signal that indicates whether a subpixel sensed radiation or not.

Each one of four 7-bits majority detectors 24(1)-24(4) is:
a. Fed with four bits—one from each ADC coupled to the 7-bits majority detector—indicating how many subpixels detected radiation.
b. Fed with a 3-bit first bias signal 25.
c. Determines whether the most of the seven bits are “1” or “0”.

The fifth 7-bits majority detector 24(5) is:
a. Fed with the four output signals from the four 7-bits majority detectors 24(1)-24(4).
b. Fed with a 3-bit second bias signal 27.
c. Determines whether the most of the seven bits are “1” or “0”—whether enough subpixels of the pixels detected radiation.

The output signal of the fifth 7-bits majority detector 24(5) is the pixel output signal 107.

It should be noted that there may be provided tradeoff (that may be reflected by the values of the bias signals and/or the threshold of the ADCs) between speed and reliability.

Higher ADC thresholds require more photons to be detected by each subpixel.

Lower bias signals will require more subpixels to detect at least one photon.

As indicated above—the device can provide pixel intensity information.

It should be noted that the device may determine the intensity information and/or timing information.

A subpixel output signal value may reflect the amount of SPADs which were triggered by a packet of photons.

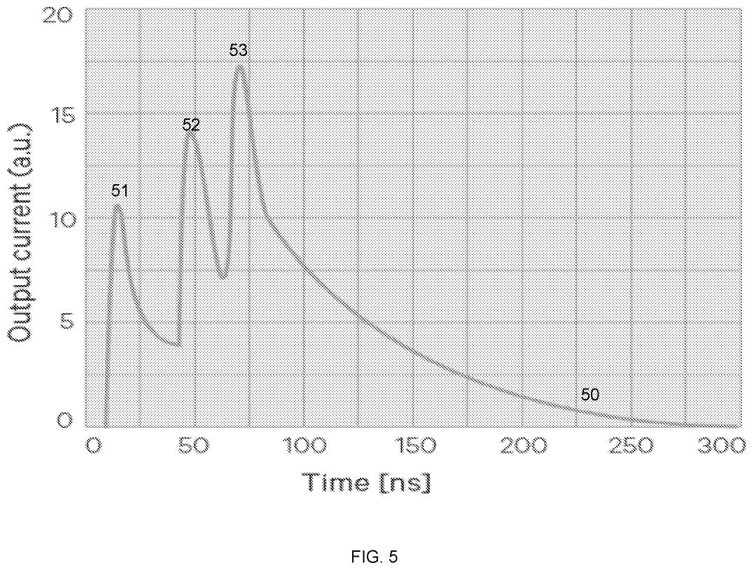

FIG. 5 illustrates an example of a current per time curve 55 that illustrates the detection of three photons (peaks 51, 52 and 53) by a certain subpixel during a certain sensing iteration.

Each peak represent a SPAD output signal of a SPAD that detected a photon.

The processing circuit may search for peaks and count the number of peaks in order to determine how many photons were detected by each subpixel.

Additionally or alternatively, the subpixel output signal may be processed in another manner (that peak counting) in order to determine how many photons were detected.

For example—referring to FIG. 5—the peaks are close enough to each other so that despite a discharging between peaks—the value of peaks increases over time.

Accordingly—the maximal value of the pixel output signal and/or the value of the subpixel output signal at a certain time window (for example—between 70 and 100 nanoseconds (ns)) may be indicative of the number of peaks.

It should be noted that the pixel intensity information may be calculated based on the intensity information included in the different subpixel output signals. For example—a pixel intensity information may reflect the sum of photons detected by each subpixels of the pixel—or the sum of validated photons.

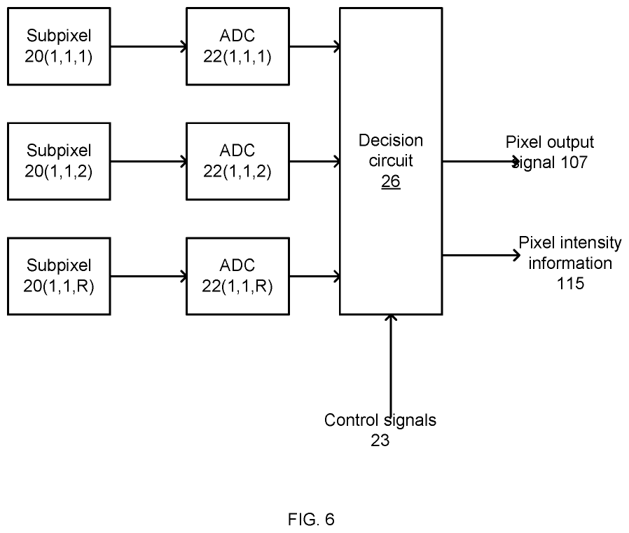

FIG. 6 illustrates a part of processing circuit 40 that outputs the pixel intensity information 115 in addition to the pixel output signal 107.

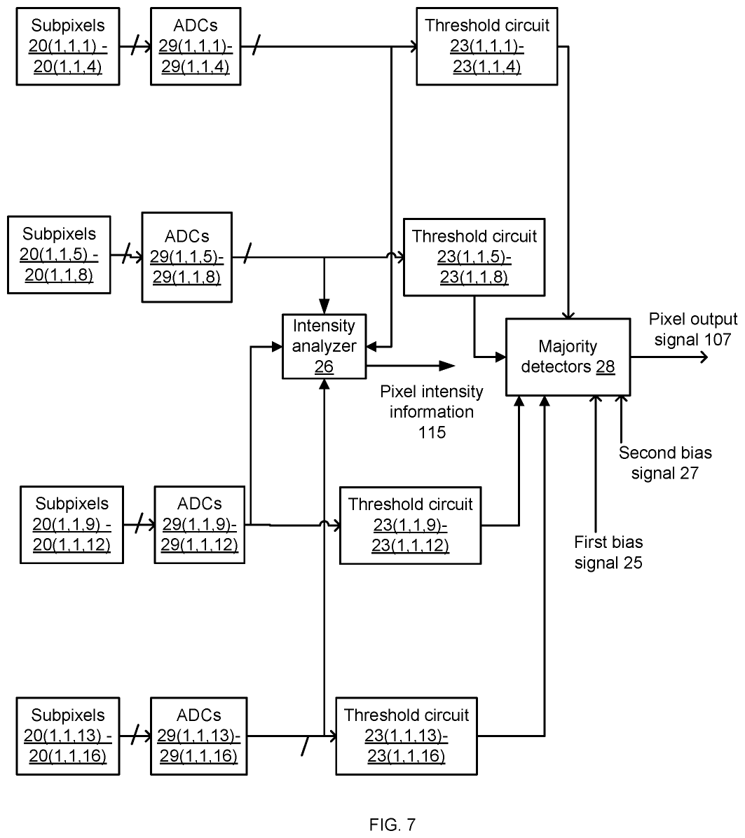

FIG. 7 illustrates a part of processing circuit 40.

It is assumed that pixel 20(1,1) includes sixteen subpixels that are denoted 20(1,1,1)-20(1,1,16). The subpixels are followed by sixteen ADCs 29(1,1,1)-29(1,1,16).

The sixteen ADCs 29(1,1,1)-29(1,1,16) are followed by an intensity analyzer 261, and by sixteen thresholding circuits 23(1,1,1)-23(1,1,16).

The sixteen thresholding circuits 23(1,1,1)-23(1,1,16) are followed by majority detectors 28.

The majority detectors 28 may include four 7-bits majority detectors 24(1)-24(4) that are followed by a fifth 7-bits majority detector 24(5). The majority detectors determine whether enough subpixels detected radiation—and output a pixel output signal 107.

Each ADC may output multiple-bit digital signals that represents the pixel output signal—and includes subpixel intensity information.

The intensity analyzer 261 may determine the pixel intensity information 115 based on the output signals of ADCs 29(1,1,1,)-29(1,1,16).

Thresholding circuits 23(1,1,1)-23(1,1,16) convert the multi-bit output signals of ADCs 29(1,1,1,)-29(1,1,16) to single bit signals (one bit per subpixel) that are fed to majority detectors 28.

It should be noted that the thresholding circuits may be omitted if the one-bit signal that is sent to the majority detectors 28 is one of the bits of the multi-bit output signals of ADCs 29(1,1,1,)-29(1,1,16).

The processing circuit of FIG. 7 provides both pixel intensity information and timing information (the time of the output of the pixel output signal 107—or timing information included in a pixel output signal 107 that is a multi-bit signal).

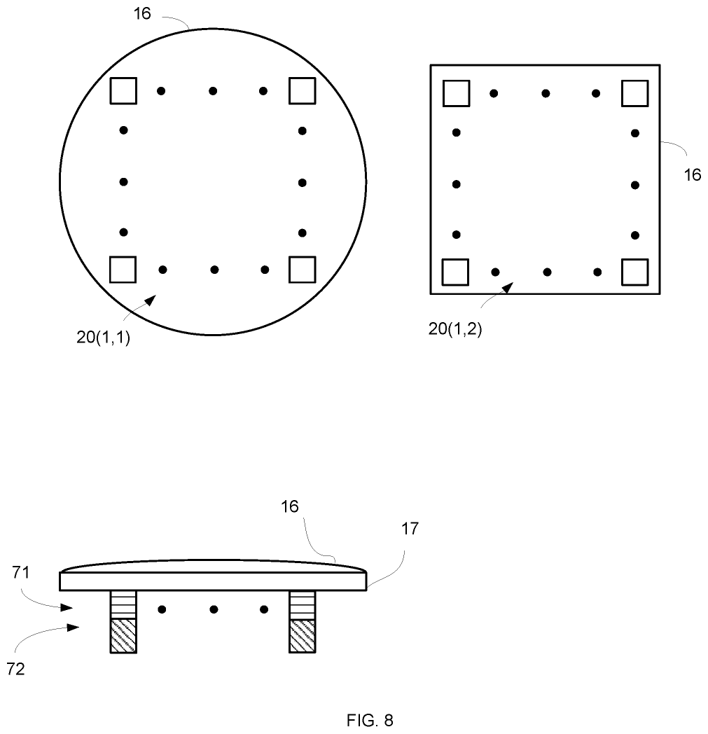

FIG. 8 includes two examples of a pixel 20(1,1) that includes multiple SPADs. The multiple SPADs are preceded by a circular lens 16 (left-top part of FIG. 8) or by a rectangular lens (right-top part of FIG. 8).

FIG. 8 (bottom) illustrates a cross section of a lens 16, color filter 17 and SPADs. FIG. 8 illustrates a backside illumination SPAD in which the silicon layers 71 of the SPADs are between the color filter 17 and the metal layers 72 of the SPADs.

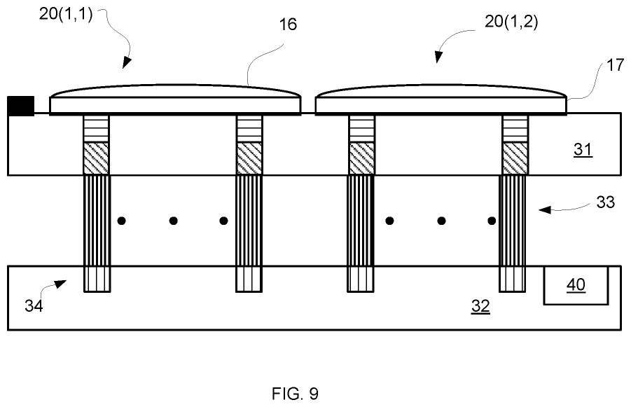

FIG. 9 illustrates a cross sectional view of a device that includes:
a. First integrated circuit 31 that includes (a) array of pixels (each pixel includes a silicon multiplier such as SM 20(1,1) and SM 20(1,2)).
b. Second integrated circuit 32 that includes processing circuit 40.
c. Inter-chip conductors 33 for electrically coupling the array of pixels to the processing circuit. The metal layers of pixels face the inter-chip conductors—which eases the connectivity between the first and second integrated circuits.

The second integrated circuit 32 may include ports and/or latches 34 or any interface that contacts the inter-chip conductors 33.

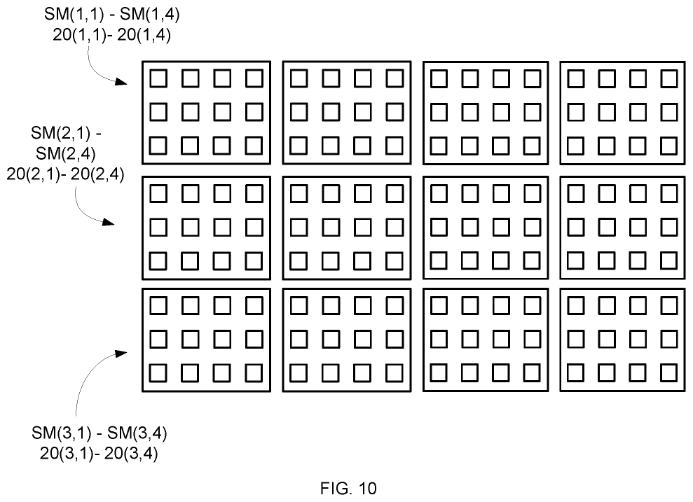

FIG. 10 illustrates an array of pixels that includes twelve silicon multipliers SM(1,1)-SM(3,4) 20(1,1)-20(3,4)—that are arranged in three rows and four columns.

The number of SMs per array of pixels may differ from twelve—and any arrangement may be provided—an ordered array of any shape, an unordered array, and the like.

There may be provided a device that may include:
a. A transmitter that is configured to transmit, per each sensing iteration, a radiation pulse.
b. An array of pixels, each pixel may include multiple subpixels, each subpixel may include single photon avalanche diodes (SPADs) that are coupled to each other in parallel, and one or more quenching circuits, wherein each subpixel is configured to output a subpixel output signal indicative of a reflected radiation pulse sensed by one or more SPADs of the subpixel; wherein the reflected radiation pulse is reflected from an area of an object that was illuminated by the radiation pulse.
c. A processing circuit that is configured to: (a) read, for each pixel, multiple subpixel output signals from the multiple subpixels of the pixel; (b) receive, per each sensing iteration, transmission timing information indicative of a timing of transmission of the radiation pulse, (c) determine, per each sensing iteration and per each subpixel, a timing of a first detection of the reflected pulse detected by any of the SPADs of the subpixel.

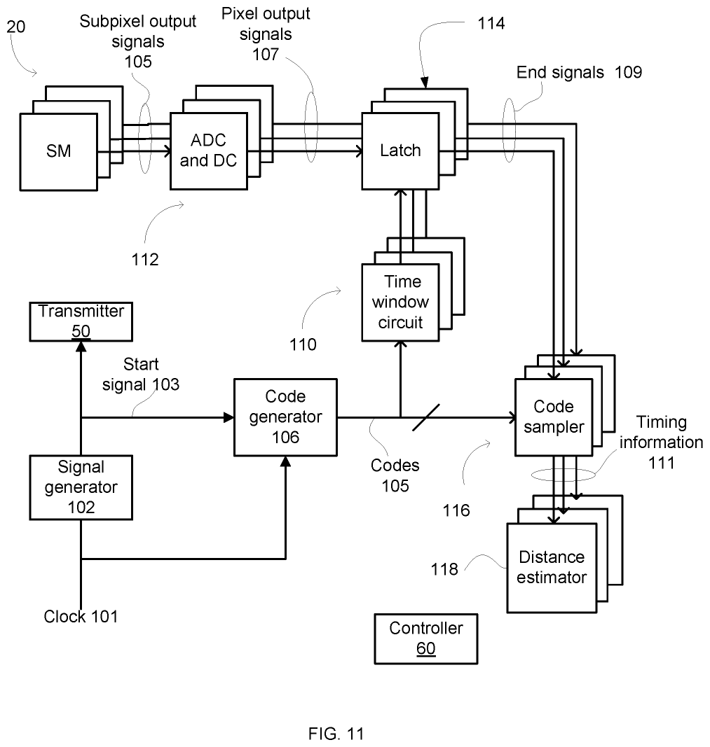

FIG. 11 illustrates a device that includes:
a. Transmitter 50.
b. Array of pixels 20, each pixel includes multiple subpixels (each subpixels may be a silicon multiplier), each subpixel outputs a subpixel output signal 105′.
c. Signal generator 102.
d. ADC and decision circuits 112 (denoted “ADC and DC”) are arranged to output the pixel output signals 107.
e. Latches 114 for outputting end signals 109 that are indicative of a timing of sensing a radiation pulse by each pixel.
f. Signal generator 102 that outputs a start signal 103 for triggering a transmission of a pulse from transmitter 50.
g. Code generator 106.
h. Time window circuits 110.
i. Code samplers 116 for outputting timing information 111.
j. Controller 60 for controlling the device.

A clock signal 101 is fed to the code generator 106 and to the signal generator 102.

ADC and DC 112, latches 114, time window circuits 110, code generator 106 and code samplers 116 may belong to a processing circuit of the device.

Time window circuits 110 are configured to ignoring pixel output signals generated outside programmable time windows. This can be done by controlling each one of the latches to latch a pixel output signal only during a time window that is associated with that latch. Different time window circuits may be programmed to the same time windows or to different time windows.

A time window may increase the signal to noise ratio—by rejecting noise outside the time window. The time window may reduce Dark Count Rate (DCR) effects and detection of light from unwanted light source. A time window corresponds to a range of distances. The device may change the time window overtime thereby searching for objects located at different distances from the device.

Code generator 106 is configured to output a sequence of codes, starting from an initial code per each sensing iteration. The start signal 103 may reset the code generator to output the initial code.

The code generator may be a pseudo random code generator.

Code samples are controlled by the end signals. Each code sampler is associated to a pixel. Each code sampler is configured to latch the output of code generator 106 to provide a code 105 at a timing that correspond to the reception of the end signal related to the pixel—the end signal is indicative of a timing of a first detection of radiation by the pixel.

The output code sampled by each code sampler is indicative of the time that passes from the transmission of the transmitted radiation pulse—and thus contains timing information.

The processing circuit may also include one or more distance estimators (denoted 118) for estimating the distance, per pixel, based on the timing difference that passed from the outputting of the initial code and the code that was sampled by the code sampler that is associated with the signal.

Thus, for a (n,m)'th pixel—(n ranges between 1 and N, m ranges between 1 and M)—and for each sensing iteration, the device executes the following steps:
a. Signal generator outputs a start signal 103.
b. Transmitter 50 transmits a transmitted radiation pulse and code generator is reset and outputs an initial code.
c. Code generator 106 outputs a sequence of codes.
d. Subpixels of the (n,m)'th pixel output subpixel output signals.
e. The (n,m)'th ADC and DC evaluates whether the (n,m)'th pixel detected a reflected radiation pulse.
f. Assuming that the (n,m)'th pixel detected a reflected radiation pulse and that the detection occurred during a time window preprogrammed to the (n,m)'th time window circuit—then the (n,m)'th latch latches a (n,m)'th pixel output signal that is indicative of a detection of the reflected radiation pulse. A reflected radiation pulse that is detected outside the time window may be ignored.
g. The (n,m)'th latch outputs an end signal 109 that causes the (n,m)'th code sampler to sample an code that represent the timing of the detection of the reflected radiation pulse by the (n,m)'th pixel.
h. The (n,m)'th code sampler than outputs the sampled code that includes timing information indicative of the timing of sensing.
i. The (n,m)'th distance estimator determines the distance based on the output code.

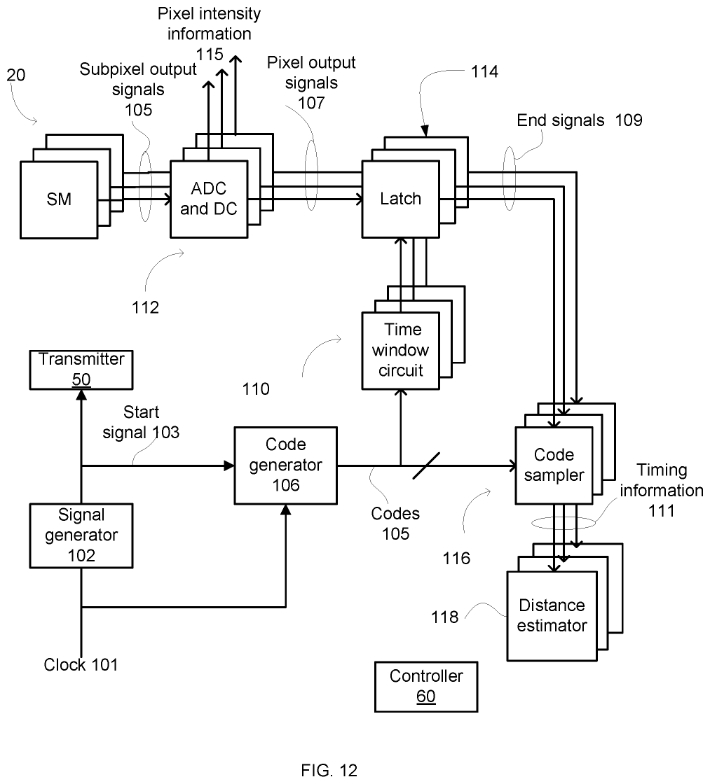

FIG. 12 illustrates a device that differs from the device of FIG. 12 by also outputting pixel intensity information 115.

The code generator may be a low jitter low power code generator that is limited by quantization nose only. First because the system is basically synchronized to a very accurate reference clock. Second, a large number of samplers may be coupled in parallel to each other—in their clock port, input port and output port, and reduce the variance of the process (also called a stochastic sampler).

The processing circuit may be fed by a single clock signal (clock 101).

Using a synchronous processing circuit simplifies the synthesis and debugging, increases immunity to noise, increases the robustness of the processing circuit and reduces noise.

The processing circuit and the array of pixels may be manufactured using CMOS technology—thereby they are cheap, reliable, small (in size) and of low power consumption.

The quenching circuits may be very compact (for example—limited to one resistor per SPAD) thus increasing the fill factor of the pixels. The fill factor being the ratio between the pixels (or the aggregate area of the SPADs) and the overall area of a surface of a chip.

The processing circuits are allocated per each sub-pixel thus increasing the fill factor of the pixels—and allowing the position the processing circuits at the periphery of the chip- or in another chip.

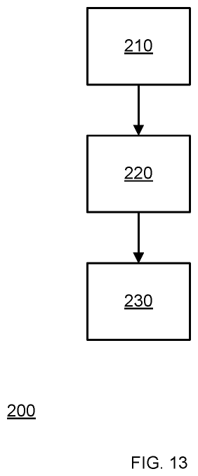

FIG. 13 illustrates a method 200 that includes:
a. Sensing, during a sensing iteration, at least one radiation pulse by at least one photon avalanche diode (SPADs) of an array of pixels, wherein each pixel of the array comprises multiple subpixels, and each subpixel comprises a group of SPADs, wherein SPADs of a subpixel are coupled to each other in parallel; outputting, by each subpixel, a subpixel output signal that is indicative any radiation pulse that impinged on any of the SPADs of the group. (Step 210).
b. Reading by a processing circuit, for each pixel, multiple subpixel output signals from the multiple subpixels of the pixel. (Step 220).
c. Generating by the processing circuit, based on the multiple subpixel output signals, at least one pixel output signal that is indicative of the radiation sensed by the at least one SPAD of the array. (Step 230).

FIG. 13 illustrates a method 300 that includes:
a. Transmitting, by a transmitter, per each sensing iteration, a radiation pulse. (Step 310).
b. Outputting, by each subpixel of an array of pixels, a subpixel output signal indicative of a reflected radiation pulse sensed by one or more single photon avalanche diodes (SPADs) of the subpixel; wherein each pixel of the array comprises multiple subpixels; wherein the SPADs of each subpixel are coupled to each other in parallel; wherein each subpixel comprises one or more quenching circuits, wherein the reflected radiation pulse is reflected from an area of an object that was illuminated by the radiation pulse. (Step 320).
c. Reading, by a processing circuit for each pixel, multiple subpixel output signals from the multiple subpixels of the pixel. (Step 330).
d. Receiving, per each sensing iteration, transmission timing information indicative of a timing of transmission of the radiation pulse. (Step 340).
e. Determining, by the processing circuit and per each sensing iteration and per each subpixel, a timing of a first detection of the reflected pulse detected by any of the SPADs of the subpixel. (Step 350).

Method 300 may include determining, by the processing circuit and per each sensing iteration and per each pixel, an intensity parameter related to one or more reflected radiation pulses detected by the pixel. (Step 360).

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation; a single operation may be distributed in additional operations and operations may be executed at least partially overlapping in time. Moreover, alternative embodiments may include multiple instances of an operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A device, comprising:
a transmitter that is configured to transmit, per each sensing iteration, a radiation pulse;
an array of pixels, each pixel comprises multiple subpixels, each subpixel comprises single photon avalanche diodes (SPADs) that are coupled to each other in parallel, and one or more quenching circuits, wherein each subpixel is configured to output a subpixel output signal indicative of a reflected radiation pulse sensed by one or more SPADs of the subpixel; wherein the reflected radiation pulse is reflected from an area of an object that was illuminated by the radiation pulse;
a processing circuit that is configured to:
read, for each pixel, multiple subpixel output signals from the multiple subpixels of the pixel;
receive, per each sensing iteration, transmission timing information indicative of a timing of transmission of the radiation pulse; and
determine, per each sensing iteration and per each subpixel, a timing of a first detection of the reflected pulse detected by any of the SPADs of the subpixel.

2. The device according to claim 1, wherein the processing circuit comprises time window circuits for ignoring pixel output signals generated outside programmable time windows.

3. The device according to claim 2, wherein the time window circuits are configured to control latches that selectively output pixel output signals.

4. The device according to claim 1, wherein the processing circuit comprises a code generator that is configured to output a sequence of codes, starting from an initial code per each sensing iteration.

5. The device according to claim 5, wherein the code generator is a pseudo random code generator.

6. The device according to claim 5, wherein the processing circuit comprises code samplers; wherein each code sampler is associated with a pixel and is configured to sample, at each sensing iteration, the code generator at a timing that correspond to the timing of a first detection of radiation by the pixel.

7. The device according to claim 1, wherein the processing circuit comprises a decision circuit for each pixel; wherein the decision circuit is configured to determine whether the pixel sensed a reflected radiation pulse per each sensing iteration; and to generate a pixel output signal according to the determination.

8. The device according to claim 7, comprising a bias circuit for biasing each decision circuit with one or more bias signals, wherein the decision circuit is configured to make the determination whether the pixel sensed the radiation pulse based on the one or more bias signal.

9. The device according to claim 8, comprising a controller for determining the one or more bias signals.

10. The device according to claim 9, wherein the controller is configured to determine the one or more bias signals based on outcomes of previous sensing iterations.

11. The device according to claim 10, wherein the controller is configured to determine the one or more bias signals based on signal to noise ratio.

12. The device according to claim 1, wherein each SPAD is coupled to a single quenching circuit that consists essentially of a resistor.

13. The device according to claim 1, wherein the processing circuit is configured to determine, per each sensing iteration and per each pixel, an intensity parameter related to one or more reflected radiation pulses detected by the pixel.

14. A method comprising:
transmitting, by a transmitter, per each sensing iteration, a radiation pulse;
outputting, by each subpixel of an array of pixels, a subpixel output signal indicative of a reflected radiation pulse sensed by one or more single photon avalanche diodes (SPADs) of the subpixel; wherein each pixel of the array comprises multiple subpixels; wherein the SPADs of each subpixel are coupled to each other in parallel; wherein each subpixel comprises one or more quenching circuits, wherein the reflected radiation pulse is reflected from an area of an object that was illuminated by the radiation pulse;
reading, by a processing circuit for each pixel, multiple subpixel output signals from the multiple subpixels of the pixel;
receiving, per each sensing iteration, transmission timing information indicative of a timing of transmission of the radiation pulse; and
determining, by the processing circuit and per each sensing iteration and per each subpixel, a timing of a first detection of the reflected pulse detected by any of the SPADs of the subpixel.

15. The method according to claim 14, comprising determining, by the processing circuit and per each sensing iteration and per each pixel, an intensity parameter related to one or more reflected radiation pulses detected by the pixel.

16. The method according to claim 15, comprising controlling by the time window circuits latches that selectively output pixel output signals.

17. The method according to claim 14, comprising outputting, by a code generator of the processing circuit, a sequence of codes, starting from an initial code per each sensing iteration.

18. The method according to claim 17, wherein the code generator is a pseudo random code generator.

19. The method according to claim 17, comprising sampling, by each code sampler of the processing circuit, at each sensing iteration, the code generator at a timing that correspond to the timing of a first detection of radiation by a pixel associated with the code sampler.

20. The method according to claim 14, comprising, determining, by each decision circuit of the processing circuit, whether a pixel associated with the decision circuit sensed a reflected radiation pulse per each sensing iteration; and generating, by the decision circuit, a pixel output signal according to the determination.

21. The method according to claim 20, comprising biasing each decision circuit by a bias circuit associated with the decision circuit and wherein the determining is based on the one or more bias signal.

22. The method according to claim 21, comprising determining, by a controller, the one or more bias signals.

23. The method according to claim 22, comprising determining by the controller the one or more bias signals based on outcomes of previous sensing iterations.

24. The method according to claim 23, comprising determining by the controller the one or more bias signals based on signal to noise ratio.

25. The method according to claim 14, wherein each SPAD is coupled to a single quenching circuit that consists essentially of a resistor.

26. The method according to claim 14, comprising determining, by the processing circuit, per each sensing iteration and per each pixel, an intensity parameter related to one or more reflected radiation pulses detected by the pixel.

27. A device, comprising:
an array of pixels, each pixel comprises multiple subpixels, each subpixel comprises single photon avalanche diodes (SPADs) that are coupled to each other in parallel, and one or more quenching circuits, wherein each subpixel is configured to output a subpixel output signal indicative of a radiation sensed by one or more SPADs of the subpixel; and
a processing circuit that is configured to:
read, for each pixel, multiple subpixel output signals from the multiple subpixels of the pixel;
generate, based on the multiple subpixel output signals, at least one pixel output signal indicative of radiation sensed by at least one of the SPADs of the array.

28. The device according to claim 27, wherein each SPAD is coupled to a single quenching circuit that consists essentially of a resistor.

29. The device according to claim 27, wherein the processing circuit is configured to determine, per each sensing iteration and per each subpixel, a timing of a first detection of radiation by any SPAD of the subpixel.

30. The device according to claim 27, wherein the processing circuit is configured to determine, per each sensing iteration and per each pixel, an intensity parameter related to radiation detected by the pixel.

31. The device according to claim 30, wherein the processing circuit is configured to determine, per each sensing iteration and per each subpixel, a timing of a first detection of radiation by any SPAD of the subpixel.

32. The device according to claim 27, wherein the processing circuit is configured to determine, per each sensing iteration and per each subpixel, timings of detection of radiation by different SPAD of the subpixel.

33. The device according to claim 27, wherein each subpixel output signal is a superposition of SPAD detection signals of SPADs that belong to the subpixel.

34. The device according to claim 33, wherein the processing circuit is configured to determine a validity of one or more SPAD detection signals of the subpixel output pixel.

35. The device according to claim 34, wherein the processing circuit is configured to ignore a SPAD detection signal that is invalid.

36. The device according to claim 27, wherein the SPADs are backside illumination SPADs.

37. The device according to claim 27, wherein the array of pixels is located in a first integrated circuit, the processing circuit is located at a second integrated circuits; and wherein the device comprises inter-chip conductors for electrically coupling the array of pixels to the processing circuit.

38. The device according to claim 27, comprising lenses that precede the array of pixels.

39. A method comprising:
sensing, during a sensing iteration, at least one radiation pulse by at least one photon avalanche diode (SPADs) of an array of pixels, wherein each pixel of the array comprises multiple subpixels, and each subpixel comprises a group of SPADs, wherein SPADs of a subpixel are coupled to each other in parallel;
outputting, by each subpixel, a subpixel output signal that is indicative any radiation pulse that impinged on any of the SPADs of the group;
reading by a processing circuit, for each pixel, multiple subpixel output signals from the multiple subpixels of the pixel; and
generating by the processing circuit, based on the multiple subpixel output signals, at least one pixel output signal indicative of the radiation sensed by the at least one SPAD of the array.

40. The method according to claim 39, wherein each SPAD is coupled to a single quenching circuit that consists essentially of a resistor.

41. The method according to claim 39, comprising determining, by the processing circuit, per each sensing iteration and per each subpixel, a timing of a first detection of radiation by any SPAD of the subpixel.

42. The method according to claim 39, comprising determining, by the processing circuit, per each sensing iteration and per each pixel, an intensity parameter related to radiation detected by the pixel.

43. The method according to claim 42, comprising determining, by the processing circuit, per each sensing iteration and per each subpixel, a timing of a first detection of radiation by any SPAD of the subpixel.

44. The method according to claim 39, comprising determining, by the processing circuit, per each sensing iteration and per each subpixel, timings of detection of radiation by different SPAD of the subpixel.

45. The method according to claim 39, wherein each subpixel output signal is a superposition of SPAD detection signals of SPADs that belong to the subpixel.

46. The method according to claim 45, comprising determining, by the processing circuit, a validity of one or more SPAD detection signals of the subpixel output pixel.

47. The method according to claim 46, comprising ignoring, by the processing circuit, a SPAD detection signal that is invalid.

48. The method according to claim 39, wherein the SPADs are backside illumination SPADs.

49. The method according to claim 39, wherein the array of pixels is located in a first integrated circuit, the processing circuit is located at a second integrated circuits; and wherein the device comprises inter-chip conductors for electrically coupling the array of pixels to the processing circuit.

50. The method according to claim 39, comprising lenses that precede the array of pixels.
